(19) United States
(12) Patent Application Publication
(10) Pub. No.: US 2011/0071799 A1
(43) Pub. Date: Mar. 24, 2011

(54) GRID MODELS

(76) Inventor: Per Arne Slotte, Trondheim (NO)

(21) Appl. No.: 12/563,810

(22) Filed: Sep. 21, 2009

(51) Int. Cl. G06F 17/50

(52) U.S. Cl. 703/1

(57) ABSTRACT

A method of forming grid models, and in particular, grid models of geological structures. In an embodiment, the method includes forming a grid model of a geological structure by forming a grid, and cutting the grid along a surface to form a grid model. The method may include identifying fault blocks and their bounding surfaces and individually forming a grid for each fault block. The grids may be cut along the bounding surfaces to form block grids which reflect the geometry of the fault block. The individual block grids may be assembled to form an assembled grid model.

### FIELD OF THE INVENTION

The present invention relates to grid models, and in particular, but not exclusively, it relates to a method of forming a grid model of a geological structure.

### BACKGROUND OF THE INVENTION

It is useful to be able to model complex physical systems in order to better understand and predict their behavior. Many natural world systems lend themselves to modeling of this kind. In the earth sciences, geological models are used to understand sub-surface behavior, for example, to estimate how fluids may flow or how other fields or signals may propagate in the sub-surface, given certain parameters and conditions.

In oil and gas applications particularly, it is useful to predict or simulate fluid flow in a hydrocarbon reservoir. For this purpose, a geological grid model of the reservoir region is typically used, where a geological model is divided into discrete cells. This division into cells facilitates numerical estimation of the fluid flow.

In order to improve accuracy of fluid flow estimates in reservoirs, it is desirable to take account of structural data. For example, it is desirable to include data regarding various discontinuities such as fault surfaces which may impact significantly on fluid flow. In existing reservoir modeling techniques, the manner and extent to which such discontinuities are taken into account differs.

A problem with proposed grid models is that incorporation of such features may result in a significant slow down of the modeling process or may prevent reliable performance and functionality altogether. This may result from trying to satisfy other constraints or conditions of processing the model data and deriving the estimate of fluid flow.

### SUMMARY OF THE INVENTION

In a first aspect of the invention, there is provided a method of forming a grid model of a geological structure, the method comprising the steps of: (a) forming a first initial grid for modeling a first geological block of the structure; (b) cutting the first initial grid along a first surface to form a first block grid; (c) forming a second initial grid for modeling a second, different geological block of the structure; (d) cutting the second initial grid to form a second block grid; and (e) assembling the first and second block grids to form an assembled grid model of the geological structure.

The method may include providing a structural model of the geological structure. The method may include defining and/or identifying model blocks of the structural model in which the model blocks represent said first and second geological blocks of the structure. The method may include identifying and/or defining bounding surfaces of the first and second model blocks. The method may include identifying surfaces of discontinuity in the structure and/or the structural model which may be a bounding surface. In this way, the model blocks that represent the geological blocks can be considered to be model geological blocks of the structural model. One or more of the geological blocks may take the form of a fault block bounded by one or more fault surfaces. The geological structure may be a hydrocarbon reservoir.

Step (b) may be performed by cutting the first initial grid along a first bounding surface to form the first block grid. Step (d) may be performed by cutting the second initial grid along a second bounding surface to form the second block grid. Thus, the first and second pre-defined surfaces may each form a bounding surface or a portion thereof. The first and second bounding surfaces may be the same surface such that cutting the first and second initial grids along the first and second bounding surfaces defines complementary outer surfaces of the first and second block grids. Step (e) may include arranging and/or locating the first and second block grids against each other along complementary outer surfaces, e.g., in contact with each other. The complementary outer surfaces may therefore be arranged in opposition to and/or facing each other when the grid is assembled.

Typically, the steps of cutting the first and second initial grids along the first and second bounding surfaces may include cutting each of the first and second initial grids along a plurality of bounding surfaces, e.g., each of their respectively identified, bounding surfaces, to form the first and second block grids. The steps of cutting the initial grids may include removing or omitting cells outside the bounding surfaces, and forming irregular cells adjacent the bounding surfaces, which irregular cells define edge surfaces that lie substantially along outer surfaces of the block grids. This may include redefining grid cells intersected by a bounding surface, typically to form irregular cells that define an edge substantially located in and/or parallel to the bounding surface. In this way, the block grid may accurately follow the geometry of the geological block, i.e., outer surfaces of the block grid are aligned with the bounding surfaces identified in the model

The step of assembling the first and second block grids may include arranging and/or fitting the first and second grids against each other along outer surfaces of the grids, e.g., without a gap, and in “contact” with each other. Thus, the outer surfaces of the block grids replicate the geometry of the geological blocks/model blocks they represent, and lie along the bounding surfaces identified in the geological structure and/or structural model when assembled to form the assembled grid model.

The bounding surfaces may form a model geological surface of the structural model. The model geological surface may represent a geological surface such as a fault surface, a geological horizon, an erosion surface or other surface which may bound, delimit and/or define the geological/model geological blocks.

The structural model may include a further plurality of model blocks, and the method may include forming respective initial grids individually for each model block, cutting the initial grids along bounding surfaces of the model blocks to form a further plurality of block grids, and/or assembling the block grids to form the assembled grid model.

By way of cutting the grids along the bounding surfaces, the first and second block grids define outer surfaces which follow the geometry of the first and second model blocks.

Steps (a) and (b) may be carried out separately from, e.g., before, respectively steps (c) and (d). In addition, steps (a) and (c) may be carried out separately from, e.g., before or after, steps (b) and (d). Thus, the method may include the step of forming independently the first and second initial grids and/or the first and second model grids for modeling the respective geological blocks.

Preferably, the step of forming the first and second initial grids is carried out before the steps of cutting the initial grids. Thus, the step of forming the first and second initial grids may be carried out without accommodating the bounding surfaces of model blocks and/or geological blocks. Forming the first and second initial grids may include selecting a resolution of each initial grid individually. The step of selecting a resolution may include defining grid cells and selecting dimensions of the grid cells. The step of forming the first and second initial grids may include selecting an orientation of each grid. The method may include optimizing resolution of grids and/or regularity and/or dimensions of grid cells, for example to facilitate processing. Thus, the orientation, resolution and dimension of cells of the initial grid are typically different for different model blocks and/or geological blocks. By way of the steps of cutting the initial grids to form the block grids, the block grids may have a grid resolution and/or orientation dependent on the grid resolution and/or orientation of the initial grid.

The initial grids and/or the block grids may be of any type. Optionally, one or more of the initial grids and/or the resulting block grids may take the form of a corner point grid. In this embodiment, the steps of forming the initial grids may include defining a plurality of columns and/or rows of grid cells, which may be regular in shape and/or spacing. The step may include selecting an orientation of the columns and/or rows of grid cells. For example, columns may be oriented substantially vertically or substantially horizontally.

The method may include the step of forming a logical array by converting the assembled grid model into a logical array or grid. Forming a logical array may include forming logical sub-arrays associated with respective first and second block grids, and the method may include arranging the logical sub-arrays for processing. The method may include linking the first and second grid blocks to one another.

The method may include calculating an area of a facing surface of the at least one block grid with an adjacent grid for determining continuity of a physical characteristic to be estimated from the one block grid to another. The physical characteristic may be a fluid flow characteristic such as transmissibility across bounding surface between blocks.

In a second aspect of the invention, there is provided a method of estimating a physical characteristic of a geological region, the method including the steps of: (a) forming a grid model according to the first aspect of the invention, wherein the block grids have a plurality of grid cells and grid cell faces defining geological model parameters; and (b) deriving a physical response based on the model parameters.

The method may include the steps of arranging the geological parameters in a logical array and processing data of the array to derive the physical response.

In a third aspect of the invention, there is provided a method of forming a grid model of a geological structure, the method comprising the steps of: forming a first block grid adapted to represent a first geological block of the structure; forming a second block grid adapted to represent a second, different geological block of the structure; and assembling the first and second blocks to form an assembled grid model of the geological structure.

### BRIEF DESCRIPTION OF THE DRAWINGS

There will now be described, by way of example only, an embodiment of the invention with reference to the accompanying drawings, of which:

FIG. 1 is a plan view of a reservoir region with fault blocks A-E according to an embodiment of the present invention;

FIG. 2 is a representation of an initial corner point grid from which a block grid of the fault blocks A-E is formed according to an embodiment of the present invention;

FIG. 3 is a plan view of an assembled grid model of the reservoir region of FIG. 1, formed from block grids for each fault block A-E;

FIG. 4 is a perspective view of two block grids juxtaposed along a boundary fault surface according to an embodiment of the present invention; and

FIG. 5 is a schematic representation of the formation of a logical or schematic array from the assembled grid model of FIG. 3.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE DRAWINGS

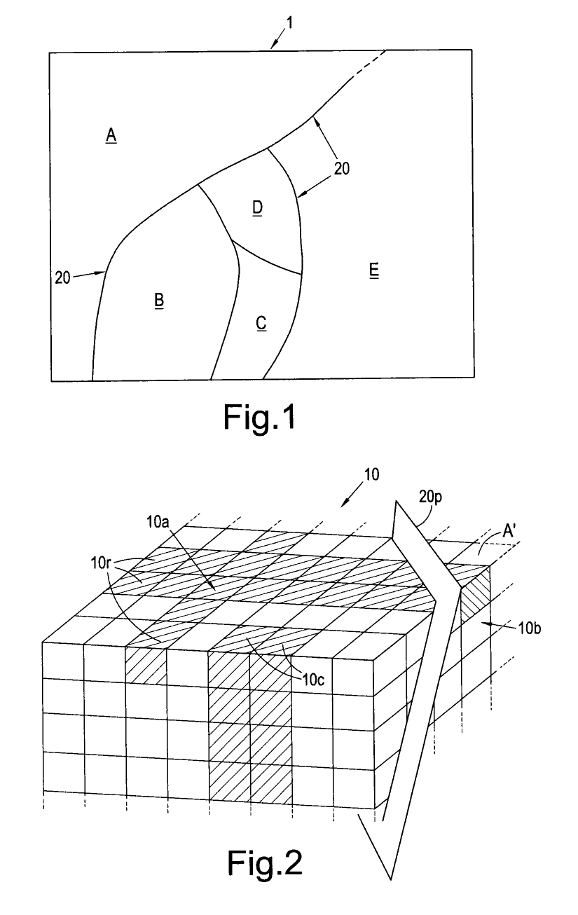

FIG. 1 shows a structural model of a reservoir region 1 in which a geological structure of the reservoir region is represented by a number of fault blocks A-E (constituting “model blocks”) delineated by bounding surfaces, including fault surfaces 20. Surface traces of the fault surfaces 20 are seen in FIG. 1.

In order to numerically simulate or model a physical behavior or characteristic in the reservoir region 1, for example to estimate fluid flow, there is formed a grid model of the geological structure. In this case, a method of forming the grid model is followed involving forming block grids individually for each of the fault blocks A-E.

A block grid for each fault block is formed, starting from an initial grid 10 as shown in FIG. 2. In this way, each block grid is formed from a separate initial grid. The initial grid is firstly defined with a volume selected to encompass the dimensions of the particular fault block to be represented by the block grid. In FIG. 2, the initial grid 10 is a simple regular grid in the form of a typical corner point grid, defining columns of cells 10c in multiple rows 10r. The cells are defined with appropriate dimensions in three orthogonal directions, thus, defining volume cells and an overall 3D volume of the grid suitable for the fault block. By defining cell dimensions, a suitable grid resolution is set, for example to take appropriate account of important features of the fault block and to facilitate speed of processing grid cells for estimating the physical characteristics to be modeled. In addition, the initial grid 10 may be oriented into a particular orientation to facilitate processing speed and reliability. The orientation and resolution of the grids may be chosen to optimize fluid simulation in the block to which it is associated.

The resolution and orientation of the initial grids may be set differently for different fault blocks. For example, one initial grid may have small cell dimensions and a fine resolution to model a thin geological model of the reservoir present in the particular fault block concerned. If such a layer is not present in the other fault blocks, the modeling grid for such other fault blocks might have a coarser grid resolution.

It will be noted that the initial grid can also be of any type, and is not limited to being of the corner point grid type illustrated in FIG. 2. For example, the grid could be a hexahedral grid. The rows and columns of the grid in FIG. 2 have a regular shape and dimensions, but it will be noted that in other cases, different rows and columns may have different widths or heights within the same initial grid.

In this way, the formation of the initial grids can be carried out independently for each fault block and the grid resolution, cell dimensions and orientation of the initial grid 10 is determined in isolation without incorporation of the bounding surfaces.

The next step is to cut the initial grid 10 along the fault surfaces 20 for the fault block, once the initial grid has been formed as described above. In the example of FIG. 2, a section 20p of the fault surface 20 is specified, and the corner point grid 10 is then cut along the section 20p where the fault surface intersects with the grid. As a result, a portion 10b outside the fault surface 20 is removed, whilst a main portion 10a of the initial grid 10 is retained to provide a basis for the block grid. The initial grid may then be cut by further surface sections (not shown), which may have different attitudes, in order to shape the grid into the required form and obtain a final block grid that closely follows the overall geometry of the fault block.

In practice, the cutting step involves removing or omitting cells outside the boundary surface, and modifying dimensions of cells which are cut by the surface. Thus, the cells which are cut are typically irregular in form, and have boundary-facing edges and points of intersection with the fault surface that lie in the plane of the bounding fault surface of the structural model.

Typically, the orientation and resolution of the initial simple regular grid may be selected to ensure that it is favorably or optimally built for data processing, for example to simulate fluid in the resulting block grid.

The optimum form of the block grid for flow simulation is typically to have a regular, k-orthogonal grid everywhere except along block boundaries. In addition, the grid resolution is varied and set (in the formation of the initial grid) according to geological complexity and/or heterogeneity. The grid orientation may be varied and set according to a main flow direction.

The steps described above are performed independently and individually for each initial grid and fault block A-E.

In this way, individual block grids 11-15 can be created and built separately for each fault block, each having an outline shape that follows exactly the geometry of the respective fault block of the structural model. The orientation and resolution of the block grid for one block will be dependent on that of the corresponding initial grid from which it was formed, and in general therefore will be independent of the grids formed and the grid properties chosen for other blocks.

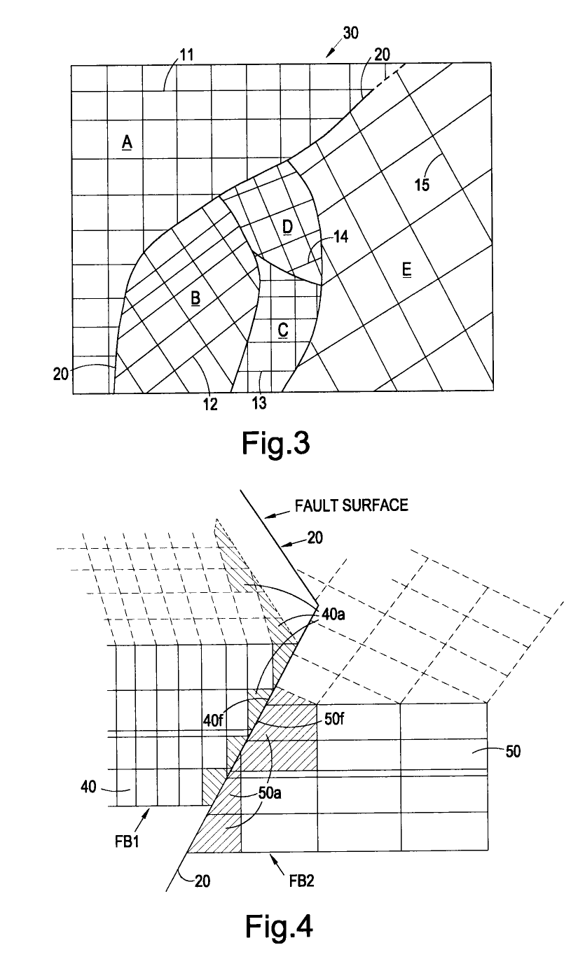

The individual grid blocks 11, 12, 13, 14 and 15 are then assembled together into an assembled or joint grid model 30 of the structure overall, as seen in FIG. 3. The block grids have different rotational orientations and cell sizes, corresponding to the selected dimensions of the initial grid, but are aligned against each other along bounding fault sections 20.

In FIG. 4, the nature of the assembled grid 30 is shown in more detail. FIG. 4 shows two modeling grids 40, 50, for example representing fault blocks A and B, juxtaposed against each other along the fault surface 20 common to these segments (along which both the initial grids for these blocks were cut). As can be seen, the cells adjacent to the common fault surface 20, for example cells 40a, 50b, have an irregular form as a result of being cut by the fault surface 20. If any of these irregular cells are very small, they are typically merged with neighbouring cells. The cells of grid 40 adjacent to the fault surface (planar or curved) have intersection points and edges that lie substantially in the fault surface. These edges can be considered to define a facing surface 40f of the grid which lies tightly against or in contact with a corresponding facing surface 50f of the adjacent grid 50, without any gap between the facing surfaces 40f, 50f.

The result is a joint or assembled model grid that very accurately represents the structural geology of the reservoir, even when the geological structures are complex.

The formation of an assembled or joint grid model in this way is particular advantageous in that selected block grids or portions of the structural model may be updated or changed, for example, to incorporate additional geological features, without affecting other parts or other grid blocks of the model. For example, one block or block grid can be modified without interfering with the rest of the grid. It can also eliminate manual editing of the grid.

Once constructed following the steps above, the grid model can be used to simulate reservoir fluid flow. In the case of fluid flow, fluid transmissibility across cells needs to be determined, including between cells of adjacent block grids across their common bounding fault surface. This may require taking into account possible sealing properties of the boundaries themselves, e.g., the sealing effect of fault surfaces. In order to do this, cells 40a, 50a that lie against the common fault surface 20 of adjacent block grids 40, 50 are linked to each other mathematically, and an area of contact of the facing surfaces 40f, 50f is determined.

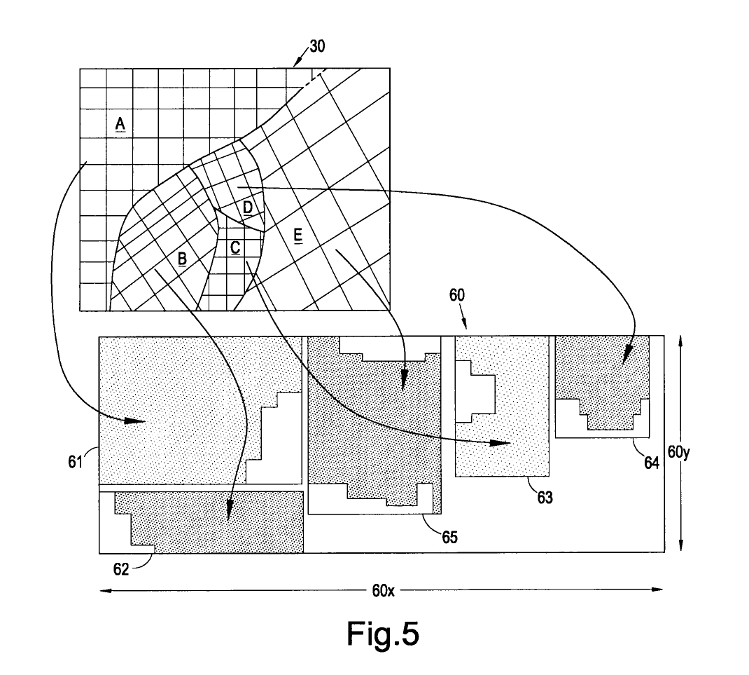

The assembled grid 30 is transformed or mapped into a logical grid or logical array 60 for processing and performing the simulation calculations as can be seen with further reference to FIG. 5. This may be done for example by splicing the individual block grids using non-neighbour connections into an i,j,k logical grid or array 60. Physical parameters and data may then be assigned to the cells of the logical array for processing, e.g., to calculate a numerical estimate of a physical property of the reservoir region, such as fluid flow. In the case of fluid flow, fluid transmissibility and volume estimations can then be output and exported to a control volume simulator package.

The logical array 60 may include sub-arrays 61, 62, 63, 64, 65 associated with respective grid blocks 11, 12, 13, 14, 15. These sub-arrays may be arranged within overall logical array 60 to optimize one or more of the dimensions 60x, 60y to facilitate processing.

The aforementioned methods, including one or more steps of the aforementioned methods, may be implemented by utilizing a computer and/or a computer-readable medium according to various embodiments.

Various modifications may be made within the scope of the invention herein described.

1. A method of forming a grid model of a geological structure comprising:
forming a first initial grid for modeling a first geological block of the geological structure;
cutting the first initial grid to form a first block grid;
forming a second initial grid for modeling a second geological block of the geological structure different than the first geological block;
cutting the second initial grid to form a second block grid; and
assembling the first and second block grids to form an assembled grid model of the geological structure.

2. The method of claim 1, further comprising:
providing a structural model of the geological structure;
identifying first and second model blocks of the structural model in which the model blocks represent said first and second geological blocks; and
identifying bounding surfaces of the first and second model blocks.

3. The method of claim 2, wherein the step of cutting the first initial grid is performed by cutting the first initial grid along a first bounding surface to form the first block grid and the step of cutting the second initial grid is performed by cutting the second initial grid along a second bounding surface to form the second block grid.

4. The method of claim 3, wherein the first and second bounding surfaces are the same surface such that cutting the first and second initial grids along the first and second bounding surfaces defines complementary outer surfaces of the first and second block grids, and the step of assembling the first and second block grids includes arranging the first and second block grids against each other along the complementary outer surfaces.

5. The method of claim 2, wherein the steps of cutting the first and second initial grids along the first and second bounding surfaces includes cutting the first and second initial grids along each of their respectively identified bounding surfaces to form the first and second block grids.

6. The method of claim 3, wherein the steps of cutting the first and second initial grids include removing cells outside the bounding surface and forming irregular cells adjacent the bounding surfaces, the irregular cells defining edge surfaces that lie substantially along outer surfaces of the block grids.

7. The method of claim 1, wherein the first and second block grids define outer surfaces following the geometry of the first and second model blocks.

8. The method of claim 1, wherein the steps of forming a first initial grid and cutting the first initial grid are carried out separately from the steps of forming a second initial grid and cutting the second initial gridssww.

9. The method of claim 1, wherein the step of forming a first initial grid is carried out before the step of cutting the first initial grid and the step of forming a second initial grid is carried out before the step of cutting the second initial grid.

10. The method of claim 1, wherein forming the first and second initial grids includes selecting a resolution of each initial grid individually.

11. The method of claim 10, wherein selecting a resolution includes defining grid cells and selecting dimensions of the grid cells.

12. The method of claim 1, wherein forming the first and second initial grids includes selecting an orientation of each grid.

13. The method of claim 1, further comprising forming a logical array by converting the assembled grid model into a logical array.

14. The method of claim 13, wherein the step of forming a logical array includes forming logical sub-arrays associated with respective first and second block grids, and arranging the logical sub-arrays for processing.

15. The method of claim 1, wherein the first and second block grids have a plurality of grid cells and grid cell faces defining geological model parameters, the method further comprising:
deriving a physical response based on the geological model parameters.

16. The method of claim 15, further comprising:
arranging the geological parameters in a logical array; and
processing data of the array to derive the physical response.

17. A method of forming a grid model of a geological structure comprising:
forming a first block grid adapted to represent a first geological block of the geological structure;
forming a second block grid adapted to represent a second geological block of the geological structure different than the first geological block; and
assembling the first and second blocks to form an assembled grid model of the geological structure.

18. The method of claim 17, wherein the steps of forming the first and second block grids are performed by cutting separate initial grids.

19. A system for forming a grid model of a geological structure comprising:
a computer including at least one data processor; and
a computer-readable medium programmed with instructions to cause the computer to:
form a first initial grid for modeling a first geological block of the geological structure;
cut the first initial grid to form a first block grid;
form a second initial grid for modeling a second geological block of the geological structure different than the first geological block;
cut the second initial grid to form a second block grid; and
assemble the first and second block grids to form an assembled grid model of the geological structure.

20. The system of claim 19, wherein the first and second block grids have a plurality of grid cells and grid cell faces defining geological model parameters and the computer-readable medium is further programmed with instructions to cause the computer to derive a physical response based on the geological model parameters.
